(19) United States
(12) Patent Application Publication
(10) Pub. No.: US 2013/0017709 A1
(43) Pub. Date: Jan. 17, 2013

(54) Electrical Connector

(71) Applicants: Keita Mashino, Tokyo (JP); Tadahiro Fumikura, Chiba (JP); Masayuki Aizawa, Tokyo (JP)

(72) Inventors: Keita Mashino, Tokyo (JP); Tadahiro Fumikura, Chiba (JP); Masayuki Aizawa, Tokyo (JP)

(21) Appl. No.: 13/545,572

(22) Filed: Jul. 10, 2012

(30) Foreign Application Priority Data
Jul. 15, 2011 (JP) 2011-156818

(51) Int. Cl. H01R 13/62

(52) U.S. Cl. 439/370

(57) ABSTRACT

An electrical connector having a first and second housing. The first housing for mating with a mating connector, is provided with a contact being electrically connectable with a mating contact provided in the mating connector. The second housing movably supports the first housing in a mating direction and in an opposite direction and has a lock to be locked with the mating connector. A resilient member is supported by the second housing for biasing the first housing in the mating direction.

### CROSS-REFERENCE TO RELATED APPLICATIONS

This application claims the benefit of the filing date under 35 U.S.C. §119(a)-(d) of Japanese Patent Application No.: 2011-156818, filed Jul. 15, 2011.

### FIELD OF THE INVENTION

The invention relates to an electrical connector and more particularly to a high-speed signal transmission electrical connector.

### BACKGROUND

With advancement of information processing equipment and communication equipment and increase in data volume of moving images etc., there is a demand for increasing the speed of signals used in such equipment. For example, a high-speed transmission property of 6 Gbps or more is needed for connecting servers.

Conventionally, as disclosed in U.S. Pat. No. 7,637,767, connectors shown in FIGS. 5 through 8 are known as examples of electrical connectors to be used in this high-speed signal transmission. The electrical connector 101 shown in FIGS. 5 though 8 is provided with: the first housing 110 for mating with the mating connector 130; and a metallic shell 120 secured to the first housing 110.

The first housing 110 has plural resilient contacts 111. Each resilient contact 111 is provided with: a resilient contact portion 112 located on the front side in a mating direction (that is the left side in FIG. 6); and a connecting portion 113 located on the back side in the mating direction. The resilient contact portion 112 is for elastically contact with a mating contact 150 provided at the mating connector 130. The connecting portion 113 is soldered to an insulated electrical wire C1 of a cable C.

The shell 120 has a hollow 121 therein, and the first housing 110 is secured in the hollow 121. A projection 114 is arranged at a back end of the first housing 110, and the projection 114 enters a recess 122 formed in the shell 120 to secure the first housing 110 to the shell 120. Plural pairs of locks 123 are provided at a front end of the shell 120.

On the other hand, the mating connector 130 is provided with: a mating housing 140; and multiple mating contacts 150 provided in the mating housing 140. The mating contact 150 is a male contact, and the mating connector 130 is a header. The mating connector 130 is mounted on a printed circuit board 160. The printed circuit board 160 is attached to a panel 180 by attaching screws or the like via a spacer 170 between the printed circuit board 160 and the panel 180.

In the electrical connector 101, the first housing 110 is inserted into an opening 181 arranged at the panel 180, so that the first housing 110 is mated with the mating connector 130. In this situation, a lock 123 provided at the shell 120 of the electrical connector 101 is locked with the opening 181 of the panel 180. Thus, the mating of the electrical connector 101 with the mating connector 130 is completed and the cable C and the printed circuit board 160 are electrically connected.

However, the electrical connectors 101 shown in FIGS. 5 through 8 have the following problems.

That is, when the first housing 110 is mated with the mating connector 130, as shown in FIG. 5, the manufacturing tolerances of the lock 123, the first housing 110, the mating connector 130, and the spacer 170 etc. may result in a gap A between the tip of the first housing 110 and the bottom portion of the mating housing 140. In this case, the contact point position D1, where the resilient contact portion 112 of the resilient contact 111 contacts with the mating contact 150, is located on a head side of the mating contact 150. E1 is the distance from the contact point position D1 to the head of the mating contact 150. As shown in FIG. 6, this distance E1 is shorter than that of a case where the tip of the first housing 110 abuts the bottom portion of the mating housing 140. The distance from the contact point position to the head of the mating contact 150 is a so-called stub amount. As the stub amount becomes smaller, the capacitance or inductance near the contact point changes. In designing the impedance matching, the contact point position is determined by assuming a case where the tip of the first housing 110 abuts the bottom portion of the mating housing 140, that is a case where the first housing 110 is completely mated with the mating connector 130, and then the impedance matching is designed on the basis of the stub amount according to the contact point position. Therefore, as the stub amount becomes smaller, the impedance changes with respect to the design value, thereby resulting in an unmatched impedance. Thus, the signal quality degrades and the transmission properties such as the impedance or the return loss also degrade.

On the other hand, as shown in FIG. 7, when the first housing 110 is made large not to generate the gap A, the lock 123 provided at the shell 120 may not be locked with the panel 180 due to the manufacturing tolerances of the product parts.

In view of the above problems, there is a need to provide an electrical connector in which a first housing is completely mated with a mating connector in any case and desired transmission properties are achieved without unmatched impedance, regardless of manufacturing tolerances of product parts.

### SUMMARY

The invention is related to an electrical connector having a first and second housing. The first housing for mating with a mating connector, is provided with a contact for contact with a mating contact provided in the mating connector. The second housing movably supports the first housing in a mating direction and in an opposite direction of the mating direction and has a lock to be locked with the mating connector. A resilient member is supported by the second housing for biasing the first housing in the mating direction.

### BRIEF DESCRIPTION OF THE DRAWINGS

The invention is described in more details below with reference to the embodiments shown in the drawings. Similar or corresponding details in the Figures are provided with the same reference numerals. The invention will be described in detail with reference to the following figures of which:

FIG. 1 is a schematic side view illustrating an electrical connector in a state before a first housing is mated with a mating connector;

FIG. 2 is a cross-sectional view taken along line 2-2 in FIG. 1;

FIG. 3 is a schematic side view illustrating an electrical connector in a state where the first housing is mated with the mating connector;

FIG. 4 is a cross-sectional view taken along line 4-4 in FIG. 3;

FIG. 5 is a schematic side view showing a state where a conventional electrical connector is mated with a mating connector;

FIG. 6 is a cross-sectional view taken along line 6-6 in FIG. 5;

FIG. 7 is a schematic side view showing another state where a conventional electrical connector is mated with the mating connector; and

FIG. 8 is a cross-sectional view taken along line 8-8 in FIG. 7.

### DETAILED DESCRIPTION OF THE EMBODIMENT(S)

Hereinafter, embodiments of an electrical connection structure according to the invention will be described with reference to the drawings.

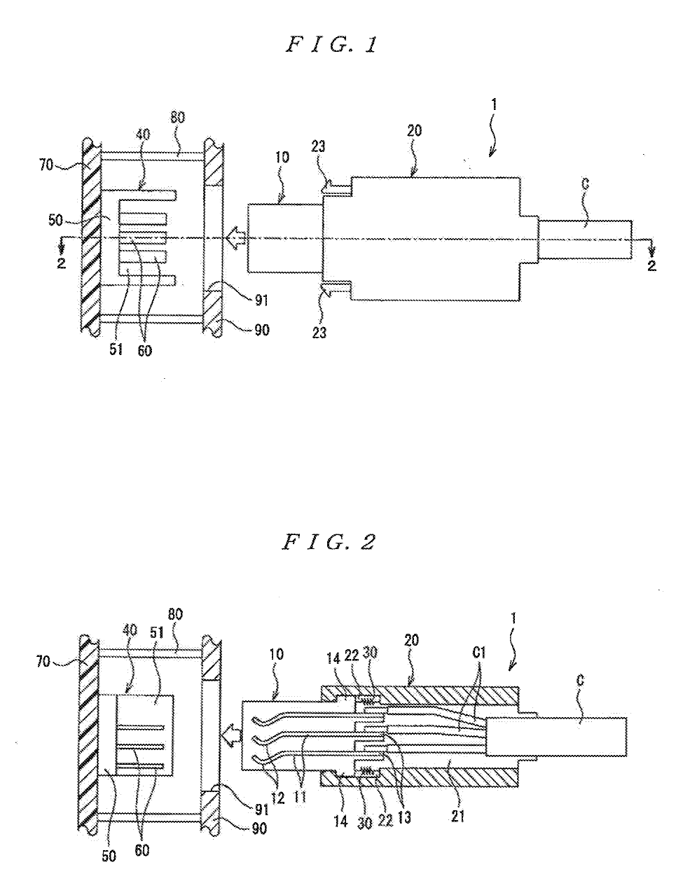

An electrical connector 1 illustrated in FIGS. 1 through 4 is suitable for high-speed signal transmission at 6 Gbps or more, for example, and is provided with: a first housing 10 for mating with a mating connector 40; a second housing 20; and plural resilient members 30.

The first housing 10 is an insulative member and has plural projections 14, for example, four projections in the present embodiment, at a back end portion. As shown, the mating direction is indicated by an arrow in FIG. 2. The plural projections 14 are provided at 90 degrees when viewed from the front of the first housing 10, which is the left surface as shown in FIG. 2.

Then, plural contacts 11 are attached to the first housing 10. Each contact 11 is provided with: a resilient contacting portion 12 arranged at a front end (left end in FIG. 2); and a connecting portion 13 arranged at a back end. Each contact 11 is made by stamping and forming a conductive metallic plate. The resilient contacting portion 12 is resiliently connected with a mating contact 60 provided in the mating connector 40. An insulated electrical wire C1 of a cable C is soldered to the connecting portion 13.

In addition, the second housing 20 is a shell member made of metal and is made by stamping and forming a conductive metallic plate. The second housing 20 has a hollow 21 therein, and movably supports the first housing 10 in the mating direction and in an opposite direction thereof in the hollow 21. There are plural recesses 22 (for example, four recesses in the present embodiment) on the front side of the hollow 21 so that the projections 14 enter the recesses 22, respectively. Since each projection 14 enters each recess 22, the plural recesses 22 are arranged at 90 degrees, when viewed from the front of the second housing 20. The movement to the front side in of the first housing 10 is restricted by the projections 14 abutting a front wall of the recess 22. On the other hand, the movement on the back side of the first housing 10 is restricted by the projection 14 abutting a back wall of the recess 22. In addition, an upper end and a lower end of the front end portion of the second housing 20 are each provided with a lock 23 to be locked with a panel 90 for supporting the mating connector 40, as will be described later.

In addition, according to the present embodiment, four resilient members 30 are provided. Each resilient member 30 is a compression coil spring, and is supported by the second housing 20 between the second housing 20 and the first housing 10 in each recess 22 of the second housing 20. Since each resilient member 30 is supported in each recess 22, the resilient members 30 are arranged at 90 degrees when viewed from the front of the second housing 20. The supporting structure of each resilient member 30 will be specifically described. A projection (not illustrated) for supporting an end of the resilient member 30 is provided at a back wall of each recess 22. On the other hand, a projection (not illustrated) for supporting the other end of the resilient member 30 is provided at a back wall of the first housing 10. Each resilient member 30 is supported by the projection on the second housing 20 and the projection on the first housing 10 to be arranged between the second housing 20 and the first housing 10. The first housing 10 is therefore biased by each resilient member 30 in the mating direction. Consequently, in a state before the first housing 10 is mated with the mating connector 40, as illustrated in FIG. 2, each projection 14 of the first housing 10 abuts the front wall of the recess 22 formed in the second housing 20.

The mating connector 40 for mating with the first housing 10 is provided with: a mating housing 50; and plural mating contacts 60 attached to the mating housing 50. The mating housing 50 has a first housing receiving cavity 51 for receiving the first housing 10. The mating connector 40 is mounted on a printed circuit board 70. One end of each mating contact 60 is connected with a conducting portion on the printed circuit board 70 by soldering or the like, and the other end thereof extends into the first housing receiving cavity 51. Each mating contact 60 is a male contact, and the mating connector 40 is a header.

Then, the printed circuit board 70 on which the mating connector 40 is mounted is attached to the panel 90 via a spacer 80 between the printed circuit board 70 and the panel 90 by an attachment screw or the like, not illustrated.

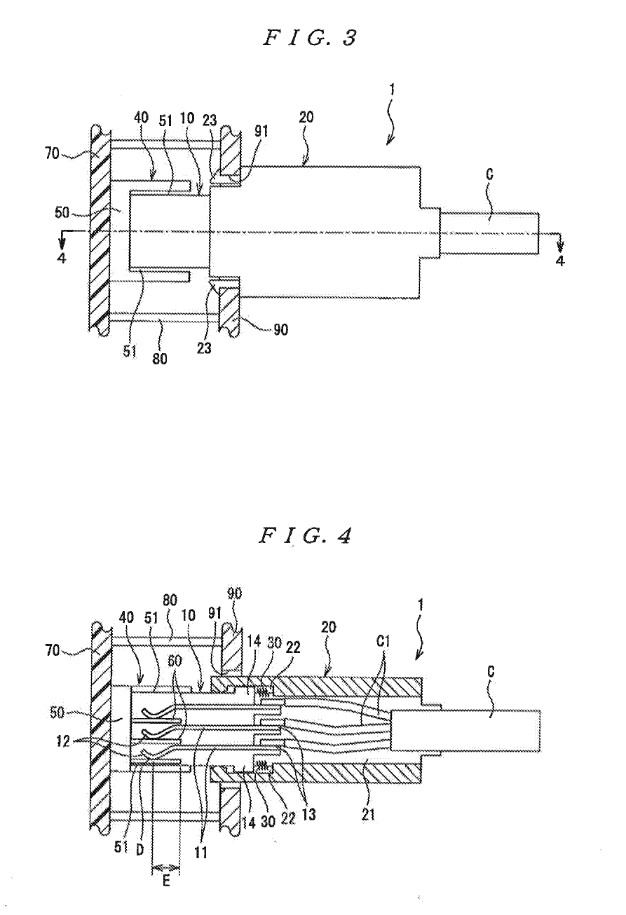

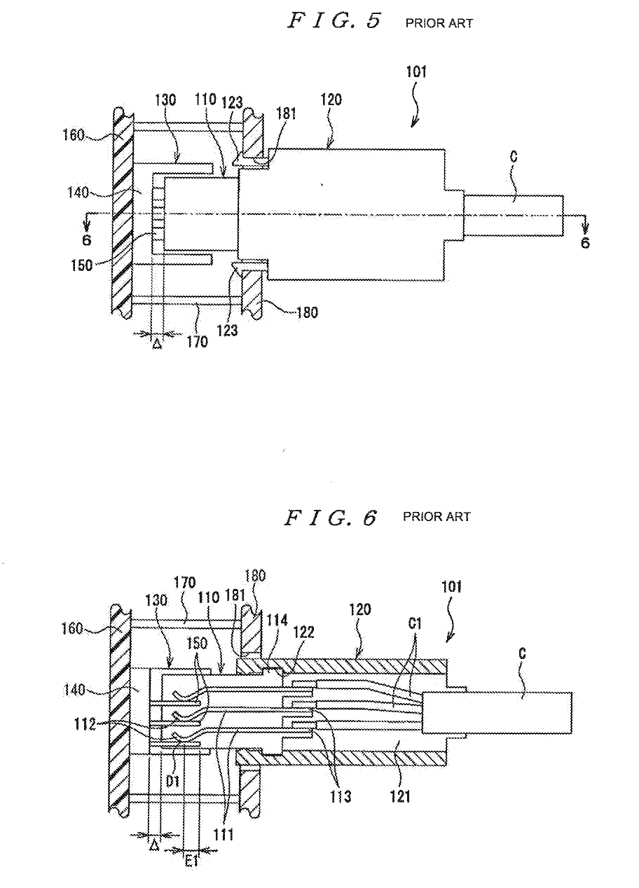

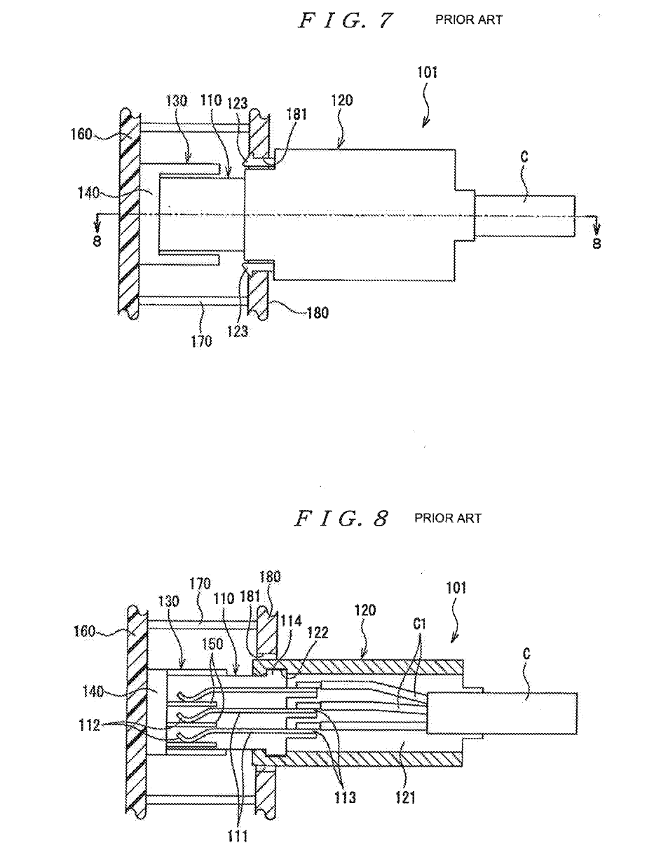

In the electrical connector 1, as illustrated in FIGS. 3 and 4, the first housing 10 is inserted through an opening 91 formed in the panel 90, so that the first housing 10 is inserted into the first housing receiving cavity 51 of the mating housing 50.

Then, when the insertion of the first housing 10 progresses, firstly, a tip of the first housing 10 abuts against the bottom of the mating housing 50. That is, the first housing 10 is completely mated with the mating connector 40. Specifically, this state is achieved as long as the repulsion forces of the resilient members 30 exceed the insertion force at the time of connector insertion. In this state, as illustrated in FIG. 4, the contacting portion 12 of the contact 11 is in contact with the mating contact 60. Hence, a cable C connected with the contacts 11 is electrically connected with the printed circuit board 70 with which the mating contact 60 is connected. Then, as illustrated, D is the contact point position where the contacting portion 12 of the contact 11 is in contact with the mating contact 60. In addition, E is a distance from the contact point position D to a head of the mating contact 60. This contact point position D corresponds to the contact point position that is determined by assuming a case where the tip of the first housing 10 abuts against the bottom portion of the mating housing 50, that is the case where the first housing 10 is completely mated with the mating connector 40. Further, the distance E corresponds to a stub amount that is determined by assuming a case where the first housing 10 is completely mated with the mating connector 40.

Moreover, when the electrical connector 1 is pressed into the mating connector 40, the first housing 10 abuts against the bottom portion of the mating housing 50 and does not move. Accordingly, no variation occurs in the contact point position D and the distance E. On the other hand, the second housing 20 and the lock 23 are inserted through the opening 91 formed in the panel 90, so that the lock 23 is locked with the panel 90. This is because the second housing 20 supports the first housing 10 movably in the mating direction and in an opposite direction thereof At the time of locking, the second housing 20 advances against the spring forces of the resilient member 30, and the front wall portion in the mating direction of the recess 22 provided in the second housing 20 is spaced apart from each projection 14 of the first housing 10. When the lock 23 is locked with the panel 90, the mating of the first housing 10 with the second housing 20 is completed.

Product parts such as the lock 23, the first housing 10, the mating connector 40, the spacer 80, and the like have manufacturing tolerances. However, the first housing 10 is completely mated with the mating connector 40 in any case. Therefore, no variation occurs in the contact point position D and the distance E. Additionally, the second housing 20 is locked with the panel 90 by the lock 23 with certainty. It is therefore possible to provide the electrical connector 1 in which desired transmission properties are available without unmatched impedance.

This is because the first housing 10 is movably supported by the second housing 20 having the lock 23 and in addition, the resilient members 30 supported by the second housing 20 bias the first housing 10 in the mating direction.

Furthermore, in the electrical connector 1 according to the present embodiment, the resilient member 30 is a compression coil spring. Therefore, with a simple structure, it is possible to support and bias the first housing 10 with the second housing 20 in the mating direction.

Heretofore, the embodiments of the present invention have been described. However, the present invention is not limited thereto, and modifications and improvements to those embodiments may occur.

For example, an object with which the lock 23 is locked is not limited to the panel 90, and may be locked with the mating connector 40 itself, or any other connecting member other than the panel connected with the mating connector 40.

In addition, the resilient member 30 is not necessarily a compression spring, and may have an elastic structure such as elastic elastomer as long as it biases the first housing 10 in the mating direction.

Furthermore, the second housing 20 is not limited to a metallic shell member, and may be an insulating member.

In addition, plural resilient members 30 are not necessarily provided, and a single resilient member 30 may be provided. Furthermore, when plural resilient members 30 are provided, they are not necessarily arranged at 90 degrees when viewed from the front of the second housing 20 as long as the first housing 10 can be biased stably in the mating direction.

What is claimed is:

1. An electrical connector comprising:
a first housing having a contact being matable with a mating contact of a mating connector;
a second housing movably supporting the first housing in a mating direction and in an opposite direction thereof, and having a lock to be locked with the mating connector; and
a resilient member supported by the second housing and biasing the first housing in the mating direction.

2. The electrical connector according to claim 1, wherein the resilient member is a compression coil spring.

3. The electrical connector according to claim 1, wherein an end of the resilient member is supported by a back wall of a recess of the second housing.

4. The electrical connector according to claim 3, wherein another end of the resilient member is supported by a back wall of the first housing.

5. The electrical connector according to claim 1, further comprising plural resilient members.

6. The electrical connector according to claim 5, wherein the plural resilient members comprise four resilient members.

7. The electrical connector according to claim 6, wherein the four resilient members are arranged at 90 degrees when viewed from a front of the second housing.

8. The electrical connector according to claim 1, wherein the lock is locked with a panel of the mating connector.
